(19) United States
(12) Patent Application Publication
(10) Pub. No.: US 2007/0284886 A1
(43) Pub. Date: Dec. 13, 2007

(54) Energy-free generator device

(76) Inventor: Wun-Siang Jhang, Miaoli County (TW)

Correspondence Address: BACON & THOMAS, PLLC, 625 SLATERS LANE, FOURTH FLOOR, ALEXANDRIA, VA, 22314, US

(21) Appl. No.: 11/447,841

(22) Filed: Jun. 7, 2006

(51) Int. Cl. F03G 7/08

(52) U.S. Cl. 290/1 R

(57) ABSTRACT

An energy-free generator device is comprised of a body, which a driving motor and two generators installed inside the body. The driving motor and two generators are connected by a belt, and the driving motor also connected with a battery. Using the battery to start the driving motor and then the driving motor drives the two generators. Finally, the driving motor can continually run with the electrical energy from generators. Therefore, the energy-free generator device can supply power to electric products without driving by gasoline or electrical energy and achieve the purpose of environmental protection and saving energy.

### TECHNICAL FIELD OF THE INVENTION

The invention herein relates to an energy-free generator device that can achieve the purpose of generating electric power without driving by gasoline or electrical energy.

### BACKGROUND OF THE INVENTION

Traditional generator devices are driven with gasoline or electrical energy to generate power; however, these kinds of generator devices continually consume energy and will cause mass of energy gradually depletion. Therefore, these driving methods do not meet requirements of environmental protection and have to be improved.

### SUMMARY OF THE INVENTION

The primary objective of the invention is to meet requirements of environmental protection and save energy by using an energy-free generator device that doesn't consume much energy to generate power.

The energy-free generator device is comprised of a body, which a driving motor and two generators installed inside the body. The driving motor and two generators are connected by a belt, and the driving motor also connected with a battery. Using the battery to start the driving motor and then the driving motor drives the two generators. Finally, the driving motor can continually run with the electrical energy from generators. Therefore, the energy-free generator device can supply power to electric products without driving by gasoline or electrical energy and achieve the purpose of environmental protection and saving energy.

The two generators, installed in the body of the energy-free generator device, connect with the driving motor are DC (direct current) or AC (alternating current) generators.

### BRIEF DESCRIPTION OF DRAWINGS

FIG. 1 is a perspective view of the preferred embodiment of the invention.

FIG. 2 is a block diagram of the invention.

FIG. 3 is an illustration for activity of the invention.

FIG. 4 is a block diagram for illustration of the invention.

### DETAILED DESCRIPTION OF THE INVENTION

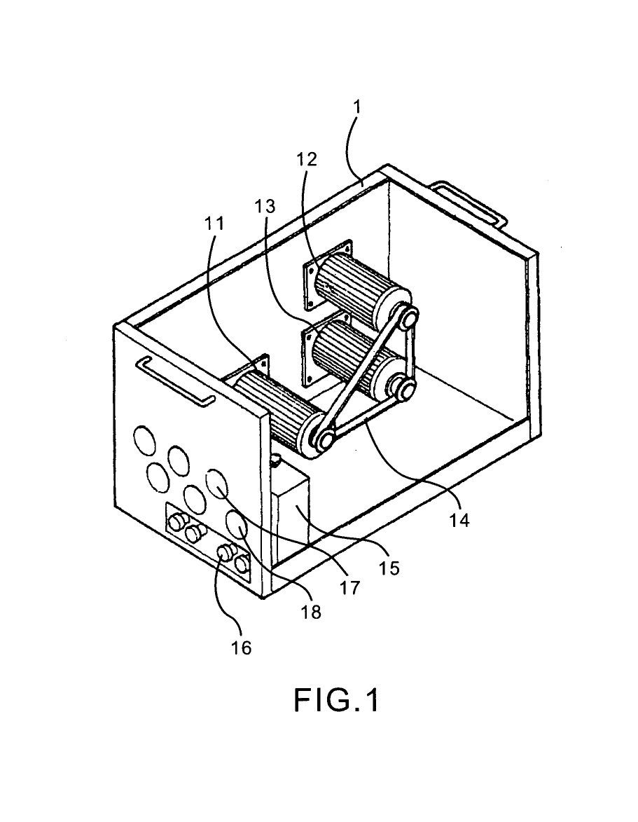

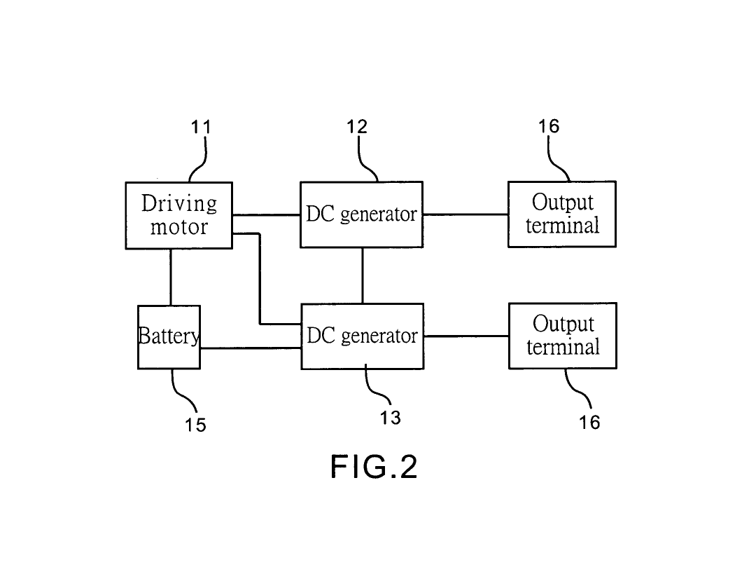

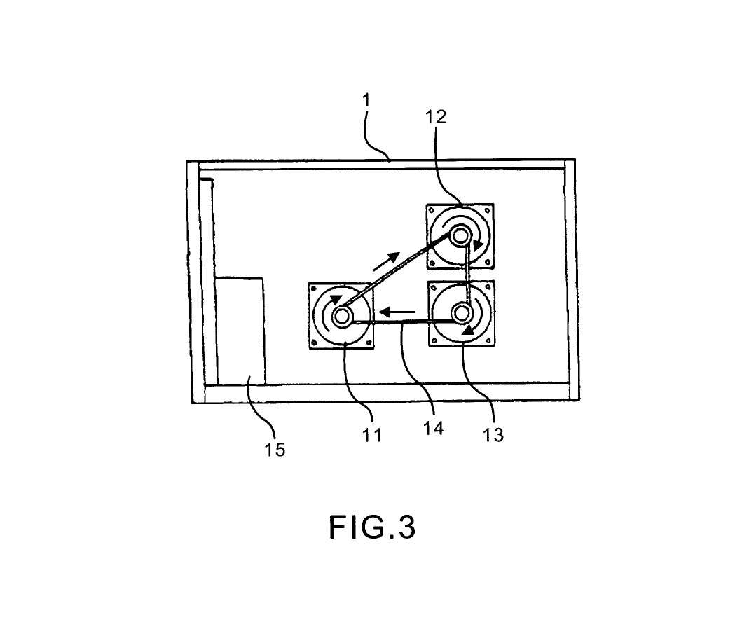

Referring to FIG. 1, FIG. 2 and FIG. 3, the structural configuration of the invention herein is comprised of a body 1, which a driving motor 11 and two DC generators 12, 13 installed inside the body. The two generators 12, 13 herein are set as DC 12V 800W. The driving motor 11 and two DC generators 12, 13 are connected by a belt 14, and the driving motor 11 also connected with a battery 15. One side of the body 1 installed output terminals 16, and voltmeters 17 and ammeters 18 are on top of the output terminals 16.

Combining these components to construct an energy-free generator device. Using the battery 15 to start the driving motor 11 and then the driving motor 11 drives the two DC generators 12 and 13. The driving motor 11 can continually run with the electrical energy from the two DC generators 12 and 13. Through output terminals 16, the electrical energy of the two DC generators 12 and 13 can be supplied to electric products, such as refrigerators, televisions, lights . . . and so on. Therefore, the energy-free generator device can supply power to electric products without driving by gasoline or electrical energy and achieve the purpose of environmental protection and saving energy.

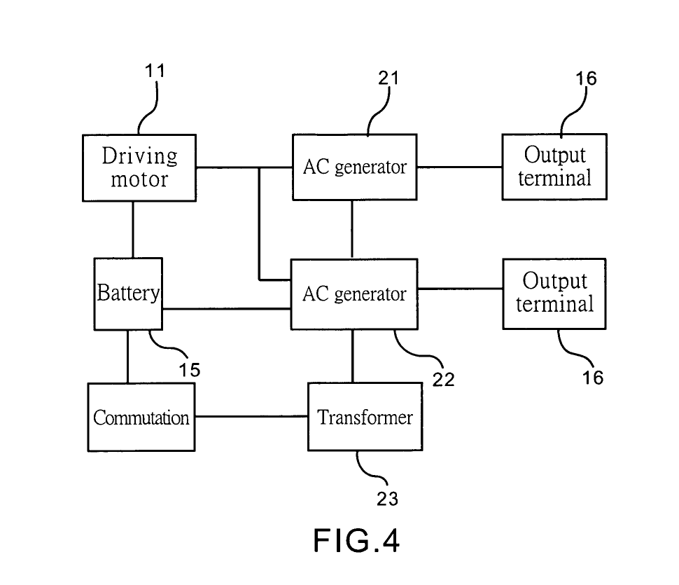

Referring to FIG. 4, the specification of DC generators 12 and 13 can be changed according to requirements. They can be changed as AC generators 21 and 22 (AC 110V 800W) and generate electric power by the driving motor 11. The two AC generators 21 and 22 herein generate 110V is transferred to AC 12V by a transformer 23 and then commutated as DC 12V to supply power to the battery 15 and the driving motor 11. The power generated from the two AC generators 21 and 22 can supply to general electric appliances.

In summation of the foregoing section, since the energy-free generator device of the invention herein is original and innovative in structure, capable of achieving its claimed objectives, and meets all new patent application requirements, the present invention is submitted for review and the granting of the commensurate patent rights.

What is claimed is:

1. An energy-free generator device is comprised of a body, which a driving motor and two generators installed inside the body;
the driving motor and two generators are connected by a belt, and the driving motor also connected with a battery;
using the battery to start the driving motor and then the driving motor drives the two generators;
finally, the driving motor can continually run with the electrical energy from generators;
therefore, the energy-free generator device can supply power to electric products without driving by gasoline or electrical energy and achieve the purpose of environmental protection and saving energy.

2. The energy-free generator device of claim 1, wherein the generators that connect with the driving motor are DC generators or AC generators.

3. The energy-free generator device of claim 1, wherein the voltage generated from the AC generators that connect with the driving motor is through a transformer to step-down and then integrated as direct current to recharge the battery and supply to the driving motor.
